(19) United States
(12) Patent Application Publication
(10) Pub. No.: US 2026/0163442 A1
(43) Pub. Date: Jun. 11, 2026

(54) ELECTRONIC DRIVE CONTROLLER WITH SENSOR INTERFACE CIRCUIT FOR TEMPERATURE MEASUREMENT WITH RTD USING WIRE RESISTANCE COMPENSATION AND ELECTRIC MOTOR ASSEMBLY

(71) Applicant: Danfoss Power Electronics A/S, Gråsten (DK)

(72) Inventors: Thomas Nielsen, Soenderborg (DK); Karsten Hjerrild, Sønderborg (DK)

(21) Appl. No.: 19/309,908

(22) Filed: Aug. 26, 2025

(30) Foreign Application Priority Data
Aug. 29, 2024 (DK) 202024104915.2

(51) Int. Cl. H02K 5/22; H02K 11/30; H02P 29/60

(52) U.S. Cl. CPC H02K 5/225; H02K 11/30; H02P 29/60

(57) ABSTRACT

An electronic drive controller (101; 201) for driving an electric motor (90) includes a reference connector (122; 222) connected to electric potential reference (GND); an analog input connector (123; 223); and an analog output connector (121; 221). The electronic drive controller (101; 201) comprises a sensor interface circuit (130; 230), which is connected to the electric reference connector (122; 222), the analog input connector (123; 223) and the analog output connector (121; 221), wherein the sensor interface circuit (130; 230) is configured for operating a resistance temperature detector (170; 270) with at least three (171, 172, 173; 271, 272, 273, 274) for temperature measurement with wire resistance compensation with applying an excitation current via the analog output connector (121; 221).

### CROSS-REFERENCE TO RELATED APPLICATION

This application claims foreign priority benefits under 35 U.S.C. § 119 to German Patent 202024104915.2 filed on 29 Aug. 2024, the content of which is hereby incorporated by reference in its entirety.

### TECHNICAL FIELD

The present invention relates to an electronic drive controller for driving an electric motor, e.g. an AC motor. It further relates to an electronic drive controller assembly comprising a resistance temperature detector and an electronic drive controller, and an electric motor assembly comprising an electric motor, a resistance temperature detector, and an electronic drive controller.

### BACKGROUND

An electric motor is typically driven by an electronic drive controller. The electronic drive controller supplies electric power to the electric motor in order to operate the electric motor.

Often, electric motors are employed in systems where at least one temperature should be measured accurately as well.

For example, the electric motor can be used in a heating, ventilation, and air conditioning system (HVAC) system and at least one room temperature should be measured accurately.

It is known to measure a temperature with a resistance temperature detector (RTD). The resistance temperature detector includes a temperature detection resistor. An ohmic resistance of the temperature detection resistor varies with the temperature. A sensor interface circuit passes a current through the resistance temperature device and senses a voltage drop over the resistance temperature device. By assuming that the voltage drop is primarily caused by the (temperature-dependent) ohmic resistance of the temperature detection resistor, changes of the temperature can be derived from changes in the measured voltage drop.

A standard resistance temperature detector includes two wires for connecting the temperature detection resistor with the sensor interface circuit. The wires itself exhibit some ohmic resistances. The ohmic resistances of the wires may differ depending on the length, the temperature of the wire, the wire square, and other factors. Hence, the ohmic resistances of the wires can impair an accuracy of the temperature measurement.

In other applications, it has been proposed to use resistance temperature detectors having at least three wires. The basic idea is to let the excitation current for the temperature detection resistor run through only two wires and to use the further wire(s) for correcting the influences of the wire resistances.

Presently, sensor interface circuits are provided as separate units. They include specific hardware and interface connectors that can be used only for operation the resistance temperature detector. Such a separate unit causes additional costs, complexity, and installation effort.

### SUMMARY

The problem underlying the invention is to provide a cost-efficient way of accurately measuring in a system, e.g. a HVAC system, that includes an electric motor.

This problem is solved by an electronic drive controller for driving an electric motor with the features according to claim 1.

The electronic drive controller comprises a reference connector connected to an electric potential reference; an analog input connector; and an analog output connector.

The electronic drive controller further comprises a sensor interface circuit, which is connected to the reference connector, the analog input connector, and the analog output connector.

The sensor interface circuit is configured for operating a resistance temperature detector with at least three wires for temperature measurement with wire resistance compensation with applying an excitation current via the analog output connector.

In other words, the sensor interface circuit (and hence the electronic drive controller) is configured for at least multi-wire mode. A multi-wire mode is an operation mode of the sensor interface circuit (and hence the electronic drive controller) for temperature measurement using resistance temperature detectors (RTDs) with wire compensation.

This requires the resistance temperature detector having at least three wires, e.g. three wires or four wires. For example, the sensor interface circuit (and hence the electronic device controller) is configured for a three-wire mode and/or a four-wire mode. A three-wire mode is a mode for temperature measurement using an RTD with wire compensation resistance, using three wires of the RTD. A four-wire mode is a mode for temperature measurement using an RTD with wire compensation resistance, using four wires of the RTD.

The sensor interface circuit is integrated into the electronic drive controller. No separate housing for the sensor interface circuit is needed. Less installation space is needed. It is not necessary for the user to install the sensor interface circuit in addition to the electronic drive controller. This reduces the effort for the installation. Further, it reduces the risk of incorrect installation and maloperation.

The electric potential reference can be, for example, a ground reference or an electric potential with a certain offset to the ground reference. The offset may be pre-determined or adjustable.

The reference connector can be a ground connector.

Optionally, sensor interface circuit (and hence the electronic drive controller) is additionally configured for a mode of temperature measurement using resistance temperature devices (RTDs) without wire compensation, also referred to as two-wire mode. In this mode, it uses only two wires of the RTD for temperature measurement.

In other words, the sensor interface circuit might be configured for operating, on the one hand, in at least one of the three-wire mode and the four-wire mode, and, on the other hand, in the two-wire mode.

Especially, operation of the sensor interface circuit (and hence the electronic drive controller) may be switchable
between the three-wire mode and the two-wire mode,
between the four-wire mode and the two-wire mode,
between the three-wire mode and the four wire mode, or
between the two-wire mode, the three-wire mode, and the four-wire mode.

The electronic drive controller can be configured such that any one of, several of, or all of the reference connector, the analog input connector, and the analog output connector can be used for other purposes when the temperature measurement is not needed. This increases the flexibility of the electronic drive controller while saving expenses and space that would be needed for additional connectors for the other purposes else.

The analog output connector and the capability of supplying a current is advantageously used for applying the excitation current for implementing the temperature measurement with wire resistance compensation in a particularly efficient, cheap, and easy manner.

In general, the RTD includes the temperature detection resistor and at least two wires. For allowing temperature with measurement wire resistance compensation, the RTD must comprise at least three wires, for example three wires or four wires. The wires are connected to the temperature detection resistor. A first wire of the at least three wires and a second wire for the at least three wires are connected to different sides (different ends) of the temperature detection resistor and are used to let the excitation current flow through the temperature detection resistor. A third wire of the at least three wires is connected to the temperature detection resistor in parallel to the one of the first wire and the second wire, e.g. in parallel to the first wire to a first side of the temperature detection resistor. An (optional) fourth wire is connected to the temperature detection resistor in parallel to the other one of the first and the second wire, e.g. in parallel to the second wire to a second side of the temperature detection resistor.

The temperature detection resistor can be mounted inside the electric motor and the at least three wires can be connected to the sensor interface circuit integrated in the electronic drive controller.

The electronic drive controller is configured such that the first wire of the at least three wires (of the resistance temperature detector) can be connected to the analog output connector, such that the second wire of the at least three wires can be connected to the reference connector and such that the third wire of the at least three wires can be connected to the analog input connector.

The sensor interface controller can be configured to sense a voltage drop between the analog input connector and the reference connector. This voltage drop is influenced by the (temperature-dependent) ohmic resistance of the temperature detection resistor (and hence by the temperature in the electric motor). For example, this voltage drop can be used to calculate the voltage drop over the temperature detecting resistor, i.e. in the two-wire mode.

The sensor interface controller is configured to compensate—in the multi-wire mode(s)—for the ohmic resistances of the first wire and the second wire by using the additional wires(s), e.g. the third wire, in order to increase an accuracy of determining the ohmic resistance of the temperature detection resistor as such (and hence to increase the accuracy of the temperature measurement). In principle, it compensates for the resistances in the two wires providing current flow through the temperature detection resistor (the first wire and the second wire).

In many cases, the wire resistance compensation in three-wire mode is sufficient. It can be assumed that the ohmic resistances in the two wires providing current flow through the thermal detection resistor are identical. By measuring and estimating the wire resistance of one of the wires providing current flow through the temperature detection resistor, it is possible to estimate the wire resistance of the other one of the two wires providing current flow through the temperature detection resistor. Resistance in the two wires providing current to the RTD would be identical.

The sensor interface circuit is configured to supply the excitation current at the first side of the temperature detection resistor via the analog output connector. The sensor interface circuit may be further configured such the excitation current (when applied via the analog output connector) does not pass through the analog input connector. The sensor interface circuit can be configured such that the complete excitation current at the second side of the temperature detection resistor passes (at least substantially) only through the reference connector and/or that the complete excitation current at the first side of the temperature detection resistor passes (at least substantially) only through the analog output connector. Especially, the sensor interface circuit may exhibit a higher impedance for current flow between the analog output connector and the analog input connector compared to an impedance for current flow through the analog output connector and the reference connector.

According to one aspect, the sensor interface circuit can comprise a compensating detection circuit. The voltage compensating detection circuit may be configured for using a voltage difference between the analog output connector and the analog input connector. Especially, it might use the electrical potentials at the analog output connector and the analog input connector as electric inputs. It may be configured to detect a voltage drop over the temperature detection resistor of the thermal resistance detector, e.g. using the voltage difference between the analog output connector and the analog input connector. The first wire and the third wire of the resistance temperature device can be connected in parallel to the first side of the temperature detection resistor. In operation, the first wire of the resistance temperature device may be connected to the analog output connector and the third wire may be connected to the analog input connector. Hence, the temperature detection resistor is located “outside” an electrical connection between the analog output connector and the analog input connector. The excitation current flows, if applied via the analog output connector, through the first wire and the second wire but not through the third wire. Since no excitation current flows through the third wire in this case, there is not voltage drop over the third wire. The voltage difference between the analog output connector and the analog input connector is hence at least indicative of the voltage drop over (and hence the ohmic resistance of) the first wire. This can be used for the wire resistance compensation.

In one embodiment, the compensating detection circuit comprises a difference amplifier (e.g., OPAMP or Operational Amplifier). The difference amplifier may include a first input and a second input. The first input can be connected to the analog output connector and the second input can be connected to the analog input connector. Due to a high input impedance of the difference amplifier, no excitation current supplied by the analog output connector (at least not substantial part thereof) flows through the analog input connector.

The difference amplifier of the compensating detection circuit may further include an amplifier output. It may be configured to output, e.g. at its amplifier output, an output signal (e.g. an output voltage) that is indicative of the voltage drop over the thermal detection resistor.

The amplifier output might be connected to the first input via an ohmic resistance (referred to as feedback ohmic resistance). The first input might be connected to the analog output connector via an ohmic resistance (referred to as connector link ohmic resistance). According to one aspect, the feedback ohmic resistance and the connector link ohmic resistance are the same.

The first input may be an inverting input.

In operation, a current through the feedback ohmic resistance and/or a current through the connector link ohmic resistance may be smaller than the excitation current, especially substantially smaller.

The compensating detection circuit may comprise an analog-to-digital converter (ADC). It may be referred to as signal ADC. The signal ADC can be coupled to the amplifier output of the compensating detection circuit. The signal ADC allows to scan said difference amplifier. Further, the signal ADC can be connected to the electric potential reference. For example, the signal ADC can be configured to provide a digital signal indicative of the voltage drop over the thermal detection resistor, e.g. to a microcontroller (MCU).

In one embodiment, said analog-to-digital converter of the compensating detection circuit (i.e. the signal ADC) is coupled to the amplifier output of the compensating detection circuit via a low-pass filter. This low-pass filter suppresses high-frequency perturbations, e.g. due to interferences. This increases the accuracy of the measurement.

According to one aspect, the sensor interface circuit may comprise a through-detection circuit for detecting a voltage between the analog input connector and the reference connector. This circuit could be also referred as two-wire mode detection circuit. In the two-wires mode, only two wires of an RTD are used. Both of these two wires are then involved in providing flow of the excitation current through the temperature detection resistor. In the two-wire mode, the one of the two wires is connected to the reference connector and the other one of the two wires is connected to the analog input connector. The excitation current may be applied via the analog input connector in this case.

The temperature detection resistor is located in series between the analog input connector on the one hand and the reference connector on the other hand. The voltage between the analog input connector and the reference connector occurs partly “through” the temperature detection resistor and is influenced by the (temperature-dependent) ohmic resistance of the temperature detection resistor. Therefore, changes in the temperature at the temperature detection resistor can be measured based on said voltage between the analog input connector and the reference connector.

The through-detection circuit may comprise an analog-to-digital converter, which may be referred to as through-detection ADC. The through-detection ADC is coupled to the analog input connector. Further, it can be connected to electric potential refence, especially to the reference connector. For example, the through-detection ADC can be configured to provide digital signals indicative of the voltage between the analog input connector and the reference connector, e.g. to the microcontroller.

In one embodiment, the analog-to-digital converter of the through-detection circuit (i.e. the through-detection ADC) is coupled to the analog input connector via a buffer and/or a low-pass filter. This low-pass filter suppresses high-frequency perturbations, e.g. due to interferences. This increases the accuracy of the measurement. The buffer facilitates stable measurement of the voltage between the analog input connector and the reference connector.

The through-detection circuit (especially the buffer, the low-pass filter of the through-detection circuit, and/or the through-detection ADC) may be configured to prevent that any (substantial) current flows between the analog input connector and the reference connector when the excitation current is applied via the analog output connector (e.g. in the three-wire mode and in the four-wire mode).

According to one aspect, the electronic drive controller comprises an analog output current applicator connected to the analog output connector. In particular, the sensor interface circuit can comprise the output current applicator. The output current applicator can be configured to apply the excitation current via the analog output connector, especially between the analog output connector and the reference connector (and hence with respect to the electrical potential reference). The output current applicator is used for applying the excitation in the at least one multi-wire modes, maybe several of or all of the multi-wire modes. For example, the excitation current is applied by the output current applicator in the three-wire mode and in the four-wire mode.

Especially, the analog output current applicator may be configured to set the excitation voltage to at least one predetermined value. Said predetermined value may be in the range from 1 V to 10 V. In one embodiment, the analog output current applicator is configured to apply an adjustable excitation voltage, for example in a voltage range from 0 V to 10 V.

Additionally or alternatively, the analog output current applicator is configured to set the excitation current. Especially, the analog output current applicator may be configured to set the excitation current to at least one predetermined value. Said predetermined value may be in the range from 0 mA to 20 mA. In one embodiment, the analog output current applicator is configured to apply an adjustable excitation current, for example in a current range from 0 mA to 20 mA.

This allows to use different excitation voltages/currents for different types of temperature detection resistors. For example, the electronic drive controller may be adjustable to apply either a first excitation voltage/current or a second excitation voltage/current which is different from the first excitation voltage/current. For example, the first excitation voltage/current may for measurement with a temperature detection resistor of the type Pt100 (ohmic resistance of 100 Ω at 0° C.) and the second excitation voltage/current may be for measurement with a temperature detection resistor of the type Pt1000 (ohmic resistance of 1000 Ω at 0° C.). It can be advantageous to keep the excitation voltage/current low in order to reduce the influence of “self-heating” of the temperature detection resistor.

The output current applicator may be connected to the microcontroller. Especially, the output current applicator may be controllable by the microcontroller.

As noted above, the sensor interface circuit can be configured for operating a resistance temperature detector (e.g. with only two wires) for temperature measurement without wire resistance compensation. In other words, the sensor interface circuit may be switchable between temperature measurement with wire resistance compensation and temperature measurement without wire resistance compensation. This increases the versatility. For example, the sensor interface circuit is configured to use only the analog input connector and the reference connector for the temperature measurement without wire resistance compensation. The sensor interface circuit/the electronic drive controller can be configured such that the analog output port can be used for other purposes when then sensor interface circuit operates the resistance temperature detector without wire resistance compensation.

In one embodiment, the electronic drive controller additionally comprises a current applicator connected to the analog input connecter. This current applicator may be referred to as second current applicator. The second current applicator can be used for applying the excitation in two-wire mode. Especially, the sensor interface circuit may include this second current applicator. The second current applicator can be configured to apply an adjustable excitation current between the analog input connector and the reference connector, for example in a current range from 0 mA to 20 mA. The second current applicator may be connected to the microcontroller and operable by the microcontroller.

The microcontroller may be configured to switch between operation of the sensor interface circuit with wire resistance compensation (e.g. with using the output current applicator for excitation) and operation of the sensor interface circuit without wire resistance compensation (e.g. with using the second current application for excitation).

The electronic drive controller may be configured to automatically switch off the output current applicator when the second current applicator is operated and/or to automatically switch off the second current applicator when the output current applicator is operated.

In one embodiment, there is a single current applicator that can be used both as the output current applicator and the second current applicator. For example, the sensor interface circuit may include a switching unit for switching an electric connection of the single current applicator with the analog output connector on the one hand and with the analog input connector at the other hand. The switching unit can include at least one semiconductor switch. Additionally or alternatively, the switching unit may be controllable by the microcontroller.

The electronic drive controller may include an external communication interface. The external communication may include any one of, several, or all of a wireless network interface, a wired network interface, a fieldbus interface, a Bluetooth™ interface, a ZigBee™ interface, a mobile phone interface, and the like. The external communication interface may be coupled to and/or included in the microcontroller. The electronic drive controller can be configured to receive operation commands via the communication interface and/or to transmit measurement data via the communication interface.

In one embodiment, the electronic drive controller is configured for supplying electric power to the electric motor as alternating current with adjustable frequency, e.g. at least in a range from 0 Hz to 100 Hz.

The electronic drive controller can comprise a drive circuit for supplying electric power to the electric motor, wherein the drive circuit includes an inverter stage. The inverter stage may comprise semiconductor switches. The semiconductor switches may be controllable by the microcontroller. The inverter stage allows to adapt the electric power supply to the electric motor.

In one embodiment, the reference connector, the analog input connector, and the analog output connector are formed in one single connector terminal. This facilitates production and decreases the manufacturing costs.

The electronic drive controller may comprise a housing, especially a single housing. All components of the drive controller may be mounted in the same housing.

According to one aspect, the sensor interface circuit is formed on an add-on module for insertion into the electronic drive controller. The sensor interface circuit may be formed on a separate circuit board (e.g. a printed circuit board, PCB) in addition to a main circuit board of the electronic drive controller. For example, the microcontroller is fixed to the main circuit board. The separate circuit may comprise an internal connection terminal for electrical connection with the main circuit board. This allows flexible and cost-effective production of electronic drive controllers with the sensor interface circuit and such ones without sensor interface circuit. Optionally, the reference connector, the analog input connector, and the analog output connector (maybe the single connector terminal, if applicable) form part of the add-on module as well. The reference connector, the analog input connector, and the analog output connector (maybe the single connector terminal, if applicable) can be fixed to the separate circuit board.

In one embodiment, the electronic drive controller comprises a further connector and the sensor interface circuit comprises a reference detection circuit for detecting a voltage between the further connector and the reference connector. The second wire of the resistance temperature device and a further wire (e.g. the fourth wire) of the resistance temperature device can be connected in parallel to the second side of the temperature detection resistor. In operation, the second wire of the resistance temperature device is connected to the reference connector and the further wire is connected to the further connector. Hence, the temperature detection resistor is located “outside” an electrical connection between the reference connector and the further connector. As the excitation current flows through the second wire but not through the further wire, the voltage between the reference connector and the further connector is indicative of an ohmic resistance of the further wire. This can be used to compensate for the ohmic resistance of the second wire for the temperature measurement. If assuming that the ohmic resistances of the further wire and the first wire, which is connected to the analog output connector, are (at least substantially) the same, this information can be used to compensate for the ohmic resistance of the first wire as well. Especially in this case, the compensating detection circuit as described above can be omitted.

The reference detection circuit can be formed similar to the compensating detection circuit described above.

In one embodiment, the reference detection circuit comprises a difference amplifier (e.g., OPAMP or Operational Amplifier). The difference amplifier may include a first input and a second input. The first input can be connected to the further connector and the second input can be connected to the analog input connector. Due to a high input impedance of the difference amplifier, no excitation current supplied via the analog output connector (or by via the analog input connector by means of the second current applicator), at least not substantial part thereof, flows through the further connector. As no current flows through the further wire, there is also no voltage drop over the further wire. Hence, an electric potential at the further connector is the same as at the second side of the temperature detection resistor. The voltage (more exactly the difference in the electric potential) between the further connector and the reference connector is hence indicative of the voltage drop over the fourth wire through which the excitation current is passed. This can be used for wire resistance compensation.

The difference amplifier of the reference detection circuit may further include an amplifier output. It may be configured to output, e.g. at its amplifier output, an output signal (e.g. a voltage).

The reference detection circuit may comprise an analog-to-digital converter (ADC) which may be referred to as reference ADC. Especially, the reference ADC can be coupled to the amplifier output (of the amplifier of the reference detection circuit). Further, the reference ADC can be connected to the electric reference potential (e.g. the ground reference). The reference ADC allows to scan the output signal of the difference amplifier (of the ground reference circuit).

In one embodiment, said analog-to digital-converter of the reference detection circuit (i.e. ground reference ADC) is coupled to the amplifier output (of the reference detection circuit) via a low-pass filter. This low-pass filter suppresses high-frequency perturbations, e.g. due to interferences. This increases the accuracy of the measurement.

In general, the sensor interface circuit can comprise
the detection circuit, or
the refence detection circuit, or
both the compensating detection circuit and the reference detection circuit.

According to one aspect, the electronic drive controller can comprise the microcontroller. The microcontroller can be connected to the signal ADC or can include the signal ADC. Additionally or alternatively, the microcontroller can be connected the through-detection ADC or can include the through-detection ADC. Additionally or alternatively, the microcontroller can be connected the reference ADC or can include the reference ADC. The microcontroller can be configured to process obtained data and to calculate the (temperature-dependent) ohmic resistance of the temperature detection sensor and/or the temperature at the temperature detection resistor.

According to one aspect, in the four-wire mode, the excitation current is passed through the temperature detection resistor via a pair of current-bearing wire, e.g. the first wire and the third wire. The voltage drop of the temperature drop resistor can be measured via a pair of sensing wires, e.g. the second wire and the further wire (the fourth wire). Since practically no current flows though any one of the sensing wire, there are no or only negligible voltage drops over the sensing wires.

The problem mentioned above is further solved by an electronic drive controller assembly according to claim 13.

The electronic drive controller assembly comprises a resistance temperature detector with at least three wires; and
an electronic drive controller for operating an electric motor according to any one of the embodiments disclosed herein;
wherein a first wire of the (at least three) wires is connected to the analog output connector, a second wire of the (at least three) wires is connected to the reference connector, and a further wire of the (at least three) wires is connected to the analog input connector or to a further connector of the resistance temperature detector.

For example, the further wire may be connected to the analog input connector (see the “third wire” as described above). In this case, the further connector may be omitted. Alternatively, the further wire may be connected to the further connector (see the “further wire” as described above). In one embodiment, further wire (a first further wire) is connected to the analog input connector and a second further wire (a fourth wire) is connected to the further connector.

The embodiments, modifications, and advantages disclosed with respect to the electronic drive controller apply accordingly, and vice versa.

The resistance temperature detector may include a temperature detection resistor. The temperature detections resistor can be a platinum measurement resistor, e.g. a Pt100 or a Pt1000. The temperature detection resistor can be a silicon resistive sensor (especially a KTY sensor), a negative temperature coefficient thermistor (NTC thermistor), or a positive coefficient thermistor (PTC).

The problem mentioned above is further solved by an electric motor assembly according to claim 14.

The electronic drive controller assembly comprises
an electric motor;
a resistance temperature detector with at least three wires; and
an electronic drive controller for operating an electric motor according to any one of the embodiments disclosed herein;
wherein a temperature detection resistor of the resistance temperature detector is accommodated in the electric motor.

As the resistance temperature detector is located inside the electric motor, the temperature inside the electric motor can be measured easily. The integration of the sensor interface circuit in the electronic drive controller reduces the size and the manufacturing costs of the assembly. Further, the assembly is easier to install, and a risk of incorrect installation is reduced. All components can be adapted to suit to each other.

The embodiments, modifications, and advantages disclosed with respect to the electronic drive controller apply accordingly, and vice versa.

The embodiments, modifications, and advantages disclosed with respect to the electronic drive controller assembly apply accordingly, and vice versa.

Additional features, advantages, and possible applications of the invention result from the following description of exemplary embodiments and the drawings. All the features described and/or illustrated graphically here form the subject matter of the invention, either alone or in any desired combination, regardless of how they are combined in the claims or in their references back to preceding claims.

### BRIEF DESCRIPTION OF THE DRAWINGS

Preferred embodiments of the invention will now be described with reference to the drawings, in which:

FIG. 1 schematically shows a first embodiment of an electronic motor assembly having an electric motor, an electronic drive controller for driving the electric motor and a resistance temperature device, wherein the latter includes a temperature detection resistor and three wires that are attached to the temperature detection resistor and are electrically connected to connectors of the electronic drive controller, wherein the electronic drive controller includes a sensor interface circuit for operating the resistance temperature device for temperature measurement with wire resistance compensation; and

FIG. 2 schematically shows a second embodiment of an electronic motor assembly similar to FIG. 1, wherein the resistance temperature device includes four wires that are attached to the temperature detection resistor and are electrically connected to connectors of the electronic drive controller; and

FIG. 3 schematically shows the first embodiment with a resistance temperature device including a temperature detection resistor and only two wires that are attached to the temperature detection resistor and are electrically connected to connectors of the electronic drive controller, wherein the sensor interface circuit and hence the electronic drive controller shown in FIG. 1 are operating in a two-wire mode temperature measurement without wire compensation measurement in FIG. 3,

FIG. 4 shows the same assembly as FIG. 1, with the modification that the temperature detection resistor is used as a room temperature sensor for heating, ventilation, and air conditioning (HVAC) system.

### DETAILED DESCRIPTION

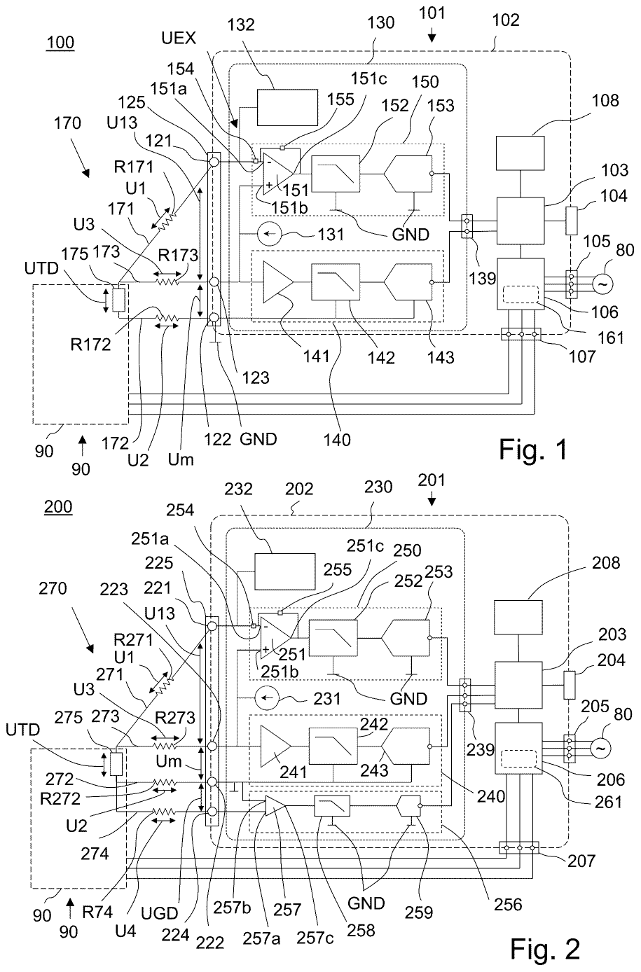

FIG. 1 schematically shows an electric motor assembly 100. The electric motor assembly 100 includes an electric motor 90, an electronic drive controller 101 for supplying the electric motor 90 with electric power for driving the electric motor 90, and a resistance temperature device 170.

The resistance temperature device 170 includes a temperature detection resistor 175, for example a platinum measurement resistor, e.g. a Pt100 or a Pt1000, a first wire 171, a second wire 172, and a third wire 173. The temperature detection resistor 175 can be mounted, for example, in the electric motor 90, inside a housing 91 of the electric motor 90 as shown in FIG. 1. For example, the temperature detection resistor 175 might be located adjacent to windings of the electric motor 90.

Different temperatures can occur in operation of the electric motor 90. A temperature in the electric motor 90 may depend on an ambient temperature, a fluid flow (like an air flow) for cooling the electric motor 90, the mechanical load driven by the electric motor 90, the speed for operation the electric motor 90, and the like.

Excessively high temperature may damage the electric motor 90. Furthermore, a high temperature can also indicate that the mechanical load applied to the electric motor 90 is too high, for example because a mechanical device driven by the electric motor 90 such suffers from malfunction, poor lubrication, or unexpected high load. Apart from that, standard operation parameters for the electric motor 90 may be not optimal if the motor temperature is very high or very low. An efficiency of the electric motor 90 may be reduced under such conditions.

However, the temperature detection resistor 175 can be placed at any desired place. The location of the temperature detection resistor 175 is not limited to the electric motor 90. The advantage of the synergistic used of the electric drive controller 101 for both driving the electric motor 90 and temperature detection using the temperature resistance detector 170 also applies if the temperature detection resistor 175 is placed at any desired place.

As an example, FIG. 4 shows an electric motor assembly 400. The electric motor assembly is a slight modification of the electric motor assembly 100 shown in FIG. 1. The only difference is that the temperature detection resistor 175 used as a temperature sensor for a heating, ventilation, and air conditioning (HVAC) system. In the non-limiting example of FIG. 4, the temperature detection resistor 175 is placed in a room 495 and used as room temperature sensor for the HVAC system.

Apart from that, FIG. 4 corresponds to FIG. 1 and hence need not be described in more detail separately.

In FIGS. 1 and 4, the first wire 171 and the second wire 172 are connected to opposites sides of the temperature detection resistor 175, i.e. at opposite ends along an electric current flowing through the temperature detection resistor 175. The first wire 171 is connected to a first side of the temperature detection resistor 175 and the second wire 172 is connected to a second side of the temperature detection resistor 175. Consequently, the temperature detection resistor 175 is connected in series between the first wire 171 and the second wire 172. The third wire 173 is connected to the first side of the temperature detection resistor 175 as well, in parallel to the first wire 171. The first wire 171 has a first ohmic resistance R171, the second wire 172 has a second ohmic resistance R172, and the third wire 173 has a third ohmic resistance R173. For the following, it is assumed that at least the ohmic resistances R171 and R172 are (at least substantially) the same.

The electronic drive controller 101 includes a housing 102, a microcontroller 103 (an MCU), a communication interface 104, a power input 105, a drive circuit 106, a motor current output 107, and optionally a memory 108. The communication interface 104, the drive circuit 106, and the memory 108 are connected to the microcontroller 103 and can be controlled by the latter, respectively.

The communication interface 104 can be used to receive data, e.g. command instructions for the electronic drive controller 101. It can be also used to transmit data from the electronic drive controller 101, e.g. measurement data.

The power input 105 is connectable to an external electrical power source 80, e.g. an alternating current source or a direct current source. The motor current output 107 is connected with the electric motor 90 for supplying electric power from the drive circuit 106 to the electric motor 90.

The drive circuit 106 includes an inverter stage 161 for adapting the electric power that is supplied to the electric motor 90. The inverter stage 161 may comprise semiconductor switches that are controllable by the microcontroller 103. The electronic drive controller 101 is configured for supplying electric power to the electric motor 90 as alternating current with adjustable frequency, e.g. in a range from 0 Hz to 100 Hz.

The electronic drive controller 101 has a connector terminal 125 which includes at least an analog output connector 121, a reference connector 122, and an analog input connector 123. The reference connector 122 is connected to an electric reference potential, for example to a ground reference GND. Therefore, the reference sign GND is exemplary used for the electric reference potential. The electric reference potential could be an electric potential with a certain offset to the ground potential as well.

The first wire 171 of the resistance temperature device 170 is connectable (and in FIG. 1 actually connected to) the analog output connecter 121, the second wire 172 is connectable (and in FIG. 1 actually connected to) the reference connector 122, and the third wire 173 is connectable (and in FIG. 1 actually connected to) the analog input connector 123.

In addition, the electronic drive controller 101 includes a sensor interface circuit 130. The sensor interface circuit 130 is adapted to operate the resistance temperature device 170 in order to allow measurement of a temperature dependent ohmic resistance of the temperature detection resistor 175. Hence, a temperature of the temperature detection resistor 175, which corresponds to a motor temperature (see FIG. 1) or a room temperature (see FIG. 4), can be determined with the electronic drive controller 101.

The sensor interface circuit 130 comprises an analog output current applicator 132 that is connected to the analog output connector 121 and configured to apply an excitation current via the analog output connector 121 (between the analog output connector 121 and the electrical potential reference GND and hence the reference connector 122). For example, the excitation current can be set to any desired value in a range from 0 mA to 20 mA. Alternatively, an excitation voltage UEX can be set to any desired value in a range from 0 V to 10 V. The analog output connector 121 may be connected to the microcontroller 103 (not shown) and may be controllable by the microcontroller 103—e.g. for switching the analog output connector 121 on and off, and/or for setting and changing the desired value of the excitation voltage UEX.

In a three-wire mode (as shown in FIGS. 1 and 4) and in a four-wire mode (as shown in FIG. 2), the excitation voltage UEX/excitation current is applied by the analog output current applicator 132. The excitation current flows from the analog output connector 121 to the reference connector 122 via the first wire 171, the temperature detection resistor 175, and the second wire 172. The ohmic resistance R171 of the first wire 171 causes a first voltage drop U1, the temperature-dependent ohmic resistance of the temperature detection resistor 175 causes a temperature-dependent voltage drop UTD and the ohmic resistance R172 of the second wire 172 causes a second voltage drop U2.

The sensor interface circuit 130 comprises a through-detection circuit 140 for detecting a voltage Um between the analog input connector 123 and the reference connector 122.

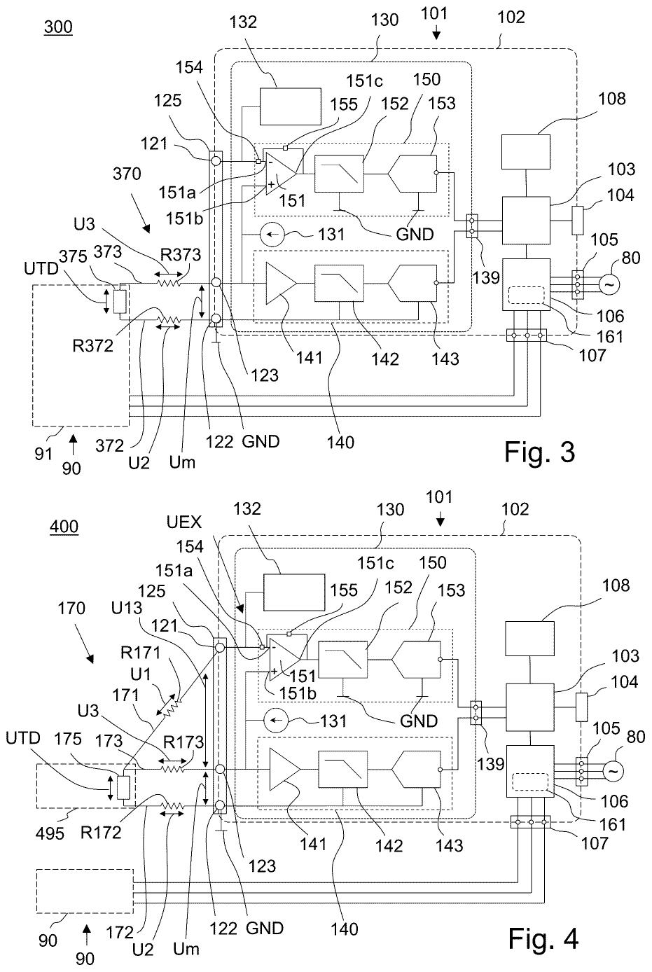

This is particularly useful for allowing also a two-wire mode temperature measurement as shown in FIG. 3. Said through-detection circuit 140 includes a buffer 141, a low-pass filter 142, and an analog-to-digital converter 143 connected in series. The analog-to-digital converter 143 is also referred to as the through-detection ADC 143. An input of the buffer 141 is connected to the analog inlet connector 123, an input of the low-pass filter 142 is connected to an output of the buffer 141, and an input of the through-detection ADC 143 is connected to an outlet of the low-pass filter 142. The through-detection ADC 143 is connected to the ground reference GND as the exemplary electric potential reference. An output of the through-detection ADC 143 provides a signal indicative of the measured voltage Um and is connected to the microcontroller 103.

Further, the sensor interface circuit 130 comprises a compensating detection circuit 150 for detecting the voltage drop UTD over the temperature detection resistor 175. It uses a voltage difference U13 between the analog output connector 121 and the analog input connector 123. The compensating detection circuit 150 includes a difference amplifier 151, a low-pass filter 152, and analog-to digital-converter 153 connected in series. The analog-to-digital converter 153 is also referred to as signal ADC 153.

A first input 151a of the difference amplifier 151 is an inverting input. It is connected to the analog output connector 121 via an ohmic resistance 154 that is referred to as connector link ohmic resistance 154.

A second input 151b of the difference amplifier 151 is a non-inverting input and is connected to the analog input connector 123.

An amplifier output 151c of the difference amplifier 151 is connected to the first input 151a via an ohmic resistance 155. The latter is referred to as feedback ohmic resistance 155. In other word, this amplifier output 151c is electrically connected to the first input 151a via an electrical connection with the feedback ohmic resistance 155.

The connector link ohmic resistance 154 and the feedback ohmic resistance 155 may have the same resistance value. Said resistance value may be comparatively high, e.g. higher than a nominal resistance of the temperature detection resistor 175 and higher than the ohmic resistances R171, R172, R173 of the wires 171, 172, 173, respectively. For example, the resistance value of the connector link ohmic resistance and the feedback ohmic resistance may be at least 10 kΩ.

In the three-wire mode as shown in FIG. 1 and FIG. 4, the excitation current for the resistance temperature device 170 is applied by the analog output current applicator 132 via the analog output connector 121.

The through-detection circuit 140 and the compensating detection circuit 150 are configured to prevent flow of the excitation current, which is provided via the analog output connector 121, through the analog input connector 123 and hence through the third wire 173. For example, the difference amplifier 151 and the buffer 141 have high impedances.

As no current (at least no substantial current) flows through the third wire 173, the voltage drop U3 over the third wire is zero (at least negligible). Since U3=0, the following applies: UTD=Um−U2−U3=Um−U2 and U1=U13−U3=U13. Since R171=R172 and since the same excitation current flows through the first wire 171 and the second wire 172, it follows: U1=U2 and hence UTD=Um−U2=Um−U1=Um−U13.

In the three- and four-wire mode operation, a current flowing from the analog output current applicator 132 to the difference amplifier 151 is much smaller than the excitation current (for example one quarter at the maximum). Due to the feedback at the difference amplifier 151, the voltage at the first input 151a is (at least substantially) the same as at the second input 151b, hence U2+UTD. Therefore, a voltage drop over the connector link ohmic resistance 154 must correspond to U1 (i.e. the voltage drop over the first wire 171).

Further, the voltage drops over the connector link ohmic resistance 154 and the feedback ohmic resistance 155 are the same. Thus, a voltage at the output 151c of the difference amplifier 151 of the compensating detection circuit 140 corresponds to UTD.

In other words, the output of the difference amplifier 151 generates a signal indicative of the temperature-dependent voltage UTD.

Said output 151c connected to an input of the low-pass filter 152. An output of the low-pass filter 152 is connected to an input of the signal ADC 153. An output of the signal ADC 153 provides a signal indicative of the temperature-dependent voltage UTD and is connected to the microcontroller 103.

Finally, a (temperature-dependent) ohmic resistance RTD (not shown in the figures) of the temperature detection resistor 175 can be calculated based on the equation RTD=UTD/IEX, where IEX is the excitation current (not shown in the figures). If assuming that IEX is constant, RTD is proportional to UTD.

Consequently, in the three-wire mode, the microcontroller 103 can calculate RTD and/or the temperature of the temperature detection resistor 175 based on the output of the compensating detection circuit 150.

Due to the three wires 171, 172, 173, the compensating detection circuit 150, and with the assumption that R171=R172, any effect of the ohmic resistances R171 and R172 onto the measurement can be compensated for. Therefore, the sensor interface circuit 130 is configured for temperature measurement with wire resistance compensation using the resistance temperature device 170 with the at least three wires 171, 172, 173.

However, the electronic drive controller 101, in particular the sensor interface circuit 130, can additionally or alternatively comprise another current applicator 131 that is connected to the analog input connecter 121.

The sensor interface circuit 130 can be also configured for temperature measurement without wire resistance compensation, using a resistance temperature device 370 with the at least two wires 372, 373, i.e. in the two-wire mode. This is illustrated in FIG. 3 showing an electric motor assembly 300. It includes the same electronic drive controller 101 as shown in FIGS. 1 and 4 but the resistance temperature device 370 instead of the resistance temperature device 170.

The resistance temperature device 370 and its operations are similar to the resistance temperature device 170 as shown in FIGS. 1 and 4. The same reference signs in the three-hundred range instead than in the one-hundred range (e.g. 372 for the second wire instead of 172) are used for the same elements as in the resistance temperature device 170. Only the differences are explained in the following. Specifically, the resistance temperature device 370 has only two-wires 372, 372 and hence can be used for measurement in two-wire mode only.

In this case, the further current applicator 131 applies an excitation current via the analog input connector 123. The voltage Um between the analog input connector 123 and the reference connector 122 is measured by the through-detection circuit 140. When assuming that the ohmic resistances R372 and R373 of the wires 372 and 373 are known and do not change, the voltage UTD can be calculated from Um as UTD=Um−U2−U3. Naturally, the excitation current should be kept constant and the electronic drive controller 101 is designed accordingly.

The sensor interface circuit 130 (in particular the through-detection circuit 140 and the compensating detection circuit 150) are configured to prevent flow of the excitation current from the further current applicator 131 through the through-detection circuit 140 and the compensating detection circuit 150. Said excitation current only flows from the further current applicator 131 via the analog input connector 123, the wire 373, the temperature detection resistor 375, the wire 372, the reference connector 122 to the electric potential reference GND.

Any one of, several of, or all of the following elements may be fixed to a main circuit board of the electronic drive controller 101: The microcontroller 103, the communication interface 104, the power input 105, the drive circuit 106, the motor current output 107, and the memory 108.

In the exemplary embodiment, the sensor interface circuit 130 and the connector terminal 125 are formed on an individual additional circuit board, which is provided in addition to the main circuit board. An internal connector 139 of the sensor interface circuit 130 connects the additional circuit board with the main circuit board and hence the sensor interface circuit 130 with the microcontroller 103. Nevertheless, the sensor interface circuit 130 and the connector terminal 125 are integrated into the housing 102 of the electronic drive controller 101 as well.

Alternatively, the sensor interface circuit 130 can be formed directly on the main circuit board.

Another embodiment of an electric motor assembly 200 is shown in FIG. 2. The electric motor assembly 200 in FIG. 2 and its operations are similar to the electric motor assembly 100.

The electronic motor assembly 200 includes another embodiment of an electronic drive controller 201. The electronic drive controller 201 and its operations are similar to the electronic drive controller 101. The same reference signs in the two-hundred range instead than in the one-hundred range (e.g. 221 for the analogue output connector instead 121) are used for the same elements as in the electronic drive controller 100. Only the differences are explained further in the following.

The electronic motor assembly 200 includes another embodiment of a temperature distance device 270. The resistance temperature device 270 and its operations are similar to the resistance temperature device 170 as shown in FIGS. 1 and 4. The same reference signs in the two-hundred range instead than in the one-hundred range (e.g. 171 for the first wire instead of 171) are used for the same elements as in the resistance temperature device 170. Only the differences are explained in the following.

The resistance temperature device 270 comprises a further wire 274 (in this case a fourth wire 274) that is connected to the second side of the temperature detection resistor 275 in parallel to the second wire 272. The electronic control device 201 includes an additional further connector 224 (a fourth connector 224) for connecting the further wire 274. As shown in FIG. 2, the further connector 224 can be formed in the connector terminal 225 as well.

The sensor interface circuit 230 is configured for temperature measurement with wire resistance compensation, namely by using the further wire 274 connected to the further connector 224 as a reference wire.

The sensor interface circuit 230 in FIG. 2 includes a reference detection circuit 256 using a voltage UGD between the further connector 224 and the reference connector 222. As shown in FIG. 2, said reference detection circuit 256 can be of similar structure as the compensating detection circuit 250. It includes a difference amplifier 257, a low-pass filter 258, and analog-to digital-converter 259 connected in series. The analog-to-digital converter 259 is also referred to as reference ADC 259. A first input 257a of the difference amplifier 257 is connected to the further connector 224 and a second input 257b of the difference amplifier 257 is connected to the reference connector 222 (or via other means to the electrical potential reference GND). A difference amplifier feedback and ohmic resistances corresponding to the connector link ohmic resistance 254 and the feedback ohmic resistance 255 in the compensating detection circuit 250 may be present but are not explicitly shown. An output 257c of the difference amplifier 257 is connected to an input of the low-pass filter 258. An output of the low-pass filter 258 is connected to an input of the reference ADC 259. An output of the reference ADC 259 provides signals and is connected to the microcontroller 203.

The reference detection circuit 256 is configured to prevent flow of the excitation current through the further connector 224 and hence through the further wire 274. For example, the difference amplifier 257 has a high impedance.

No current flows through wires 273 and 274 and hence U2=U4=0. Accordingly, it is easy and precise to calculate UTD, for example by UTD=Um−UGD.

The microcontroller 203 can be configured to calculate UTD, the (thermal-dependent) ohmic resistance RTD (not shown) of the temperature detection resistor U.

The embodiment including both the compensating detection circuit 250 and the reference detection circuit 256 is particularly useful if the ohmic resistances R271 and R272 are different. Hence, the reference detection circuit 256 is used in the four-wire mode.

Naturally, the temperature measurement without wire resistance compensation is in general less accurate than the temperature measurement with wire resistance compensation as shown in FIGS. 1, 2, and 4. However, the possibility to use this approach as well increases the versatility of the electronic drive controllers 101, 201. If higher accuracy of the temperature measurement is needed, the resistance temperature device 170, 270 with at least three wires 171, 172, 173, 271, 272, 273, 274 and the corresponding measurement mode of the electronic drive controller 101, 201 with wire resistance compensation is used. If less accuracy is needed, the resistance temperature device 370 with only two wires 372, 373 and the corresponding measurement mode of the electronic drive controller 101, 201 without wire resistance compensation can be used as shown in FIG. 3. The analog output connector 121, 221 is available for other purposes then. Furthermore, when the first wire 171, 271 in FIG. 1 or FIG. 4 is disconnected or damaged, the electronic drive controller 101, 201 might automatically switch to the measurement mode explained with regard to FIG. 3.

Naturally, the temperature detection resistor 175, 275, 375 could be placed in any other desired location, for example as shown in FIG. 4, with regard to FIG. 2 and FIG. 3 as well.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An electronic drive controller for driving an electric motor, the electronic drive controller comprising:
a reference connector connected to electric potential reference (GND);
an analog input connector; and
an analog output connector;
wherein the electronic drive controller comprises a sensor interface circuit, which is connected to the electric reference connector the analog input connector and the analog output connector, wherein the sensor interface circuit is configured for operating a resistance temperature detector with at least three for temperature measurement with wire resistance compensation with applying an excitation current via the analog output connector.

2. The electronic drive controller according to claim 1, wherein the sensor interface circuit comprises a compensating detection circuit for detecting a voltage drop (UTD) over a temperature detection resistor of the resistance temperature detector using a voltage difference (U13) between the analog output connector and the analog input connector.

3. The electronic drive controller according to claim 2, wherein the compensating detection circuit comprises:
a difference amplifier with a first input a second and an amplifier output wherein the first input is connected to the analog output connector and the second input is connected to the analog input connector; and
an analog-to-digital converter, wherein the analog-to-digital converter is coupled to the amplifier output and connected to the electric potential reference (GND).

4. The electronic drive controller according to claim 3, wherein the analog-to-digital converter of the compensating detection circuit is coupled to the amplifier output via a low-pass filter.

5. The electronic drive controller according to claim 3, wherein the electronic drive controller comprises a microcontroller and wherein the microcontroller is connected to the analog-to-digital converter of the compensating detection circuit or includes the analog-to-digital converter of the reference detection circuit.

6. The electronic drive controller according to claim 1, wherein the sensor interface circuit comprises a temperature resistor detection circuit for detecting a voltage (Um) between the analog input connector and the reference connector.

7. The electronic drive controller according to claim 6, wherein the temperature resistor detection circuit comprises an analog-to-digital-converter wherein the analog-to-digital converter is coupled to the analog input connector and connected to the ground connector.

8. The electronic drive controller according to claim 7, wherein the analog-to-digital converter of the temperature resistor detection circuit is coupled to the analog input connector via a buffer and/or a low-pass filter.

9. The electronic drive controller according to claim 1, wherein the electronic drive controller comprises an analog output current applicator connected to the analog output connector.

10. The electronic drive controller according to claim 1, wherein the electronic drive controller comprises a current applicator connected to the analog input connecter.

11. The electronic drive controller according to claim 1, wherein the electronic drive controller comprises a drive circuit for supplying electric power to the electric motor, wherein the drive circuit includes an inverter stage.

12. The electronic drive controller according to claim 1, wherein the reference connector, the analog input connector and the analog output connector are formed in one single connector terminal.

13. An electronic drive controller assembly comprising:
a resistance temperature detector with at least three wires; and
an electronic drive controller for operating an electric motor according to claim 1;
wherein a first wire of the wires is connected to the analog output connector, a second wire of the wires is connected to the reference connector and a further wire of the wires is connected to the analog input connector or to a further connector of the resistance temperature detector.

14. An electric motor assembly comprising:
an electric motor;
a resistance temperature detector with at least three wires; and
an electronic drive controller for operating the electric motor according to claim 1.

15. The electric motor assembly according to claim 14, wherein a first wire of the wires is connected to the analog output connector second wire of the wires is connected to the reference connector and a further wire of the wires is connected to the analog input connector or to a further connector of the resistance temperature detector.
